(19) United States
(12) Patent Application Publication
(10) Pub. No.: US 2022/0332011 A1
(43) Pub. Date: Oct. 20, 2022

(54) METHOD FOR INJECTING A DECORATED ITEM

(71) Applicant: Comadur SA, Le Locle (CH)

(72) Inventors: Pascal CHOPARD-LALLIER, Montlebon (FR); Julien MOREAU, Morteau (FR)

(73) Assignee: Comadur SA, Le Locle (CH)

(21) Appl. No.: 17/657,660

(22) Filed: Apr. 1, 2022

(30) Foreign Application Priority Data
Apr. 20, 2021 (EP) 21169506.9

(51) Int. Cl. B28B 7/00; B28B 1/24; B28B 11/24; B28B 11/08; B28B 7/38; B22F 3/22; B22F 3/00; B22F 3/24; G04B 19/18; G04D 3/00

(52) U.S. Cl. CPC B28B 7/0076; B28B 1/24; B28B 11/243; B28B 11/0845; B28B 7/38; B22F 3/225; B22F 3/003; B22F 3/24; G04B 19/18; G04D 3/0069; G04D 3/0051; B22F 2003/247

(57) ABSTRACT

A method for machining by laser ablation or by micro-milling a raised and/or hollow structure on an impression of an injection mould. A method for manufacturing a ceramic or cermet item by injection using the injection mould to produce an item, and in particular a watch bezel, decorated directly during the injection.

TECHNICAL FIELD

The present invention relates to a method for machining a raised and/or hollow structure in an injection mould and to the method for manufacturing a decorated item obtained by injection of a ceramic material or by cermet within said mould. It also relates to the item, and more particularly to a watch component such as a bezel, produced with said manufacturing method as well as to the mould obtained by the machining method.

### PRIOR ART

Ceramic or cermet watch components are obtained by an injection method including a step of sintering the green body obtained after injection. These components often have a decoration, such as indexes and numbers for bezels, which is machined after the injection method. These decorations have the feature of being very fine and therefore require extreme precision to obtain a quality engraving. Generally, the decorations are made by laser ablation with engraving times that can go beyond an hour. This post-injection decoration step therefore generates additional manufacturing costs and times.

### SUMMARY OF THE INVENTION

The object of the present invention is to overcome the aforementioned disadvantages by proposing a new manufacturing method where the decoration is carried out at the same time as the injection so as to avoid the engraving step after the injection.

To this end, the present invention relates to a method for manufacturing an item comprising a step of injecting the material into a mould comprising an impression with a raised and/or hollow structure which is the negative of the decoration of the item to be manufactured. According to the invention, the raised and/or hollow structure on the impression is produced by laser engraving or by micro-milling. The structure to be produced is extremely fine with at least one dimension less than or equal to 1.5 mm, preferably 1 mm and more preferably 0.5 mm.

Thus, the present invention relates to the method for machining the impression of the mould and to the method for manufacturing the item involving a step of providing the mould obtained according to this machining method.

More specifically, it relates to the method for machining by laser ablation or by micro-milling a raised and/or hollow structure on an impression of an injection mould, said structure being made of one element or several separate elements with at least one element having at least one dimension less than or equal to 1.5 mm, said dimension being selected from a minimum height or depth of the respectively raised or hollow element and a minimum distance separating two opposite faces of said element in a plane transverse to said height or depth.

More specifically, it relates to the method for manufacturing the item comprising the following steps:

Providing an injection mould which includes at least one impression with the raised and/or hollow structure,
Providing at least one ceramic or cermet material,
Injecting said at least one material into said at least one impression of the mould to form a green body provided with a decoration which is the negative of the structure of the impression,
Sintering the green body to form a blank,
Finishing the blank to obtain the item.

The method for manufacturing the item according to the invention thus allows to remove the step of decorating the item after the injection. This significantly reduces manufacturing costs and times.

The item decorated during the injection is made in one piece without discontinuity between the decoration and the rest of the item, unlike an item decorated by soldering or gluing the elements of the decoration onto the item.

Compared to an item decorated by laser ablation, the item with a decoration produced during the injection has a shinier, less rough surface condition, without marks from the successive passages of the laser, which possibly allows to dispense with a final polishing step.

Other features and advantages of the present invention will appear in the following description of a preferred embodiment, presented by way of non-limiting example with reference to the appended drawings.

### BRIEF DESCRIPTION OF THE FIGURES

FIG. 1 shows a plan view of a bezel manufactured with the method according to the invention.

FIGS. 2A and 2B show respectively a partial plan and three- dimensional view of a bezel manufactured with the method according to the invention, the dimensions being given in millimetres.

FIG. 3A shows a three-dimensional view of the mould provided with an impression including a hollow structure intended to form the raised decoration of a watch bezel during the injection method. FIG. 3B is an enlarged view of said impression. Alternatively, FIG. 4 shows a three-dimensional view of the mould provided with an impression including a raised structure intended to form the hollow decoration of a watch bezel during the injection method.

FIG. 5a shows the green body obtained at the end of the step of injecting two distinct materials with FIGS. 5b and 5c which separately show the two materials constituting the green body.

FIG. 6 is a plan view of the green body of FIG. 5a with the internal structure of the green body in dotted lines. FIG. 6a is a sectional view along the axis A-A of FIG. 6 with the arrows showing the direction of flow of the second material during injection.

FIG. 7a shows the item obtained at the end of a manufacturing method by injection of two distinct materials with FIGS. 7b and 7c which separately show the two materials constituting the item.

FIG. 8 schematically illustrates a step of machining the ridge of the decoration during the finishing of the item.

### DETAILED DESCRIPTION

The present invention relates to a method for machining a hollow and/or raised structure on an impression of a mould intended for the injection of a ceramic or cermet material. It also relates to the mould obtained by this machining method. It also relates to the method for manufacturing an item by injection, making use of this mould for the injection. The present invention further relates to the decorated item resulting from the manufacturing method.

According to the invention, the decoration is raised and/or hollow on the item. The decoration can be made of a single element such as an acronym or made of several distinct elements such as indexes and numbers. It is possible that some elements are raised and others are hollow within the decoration.

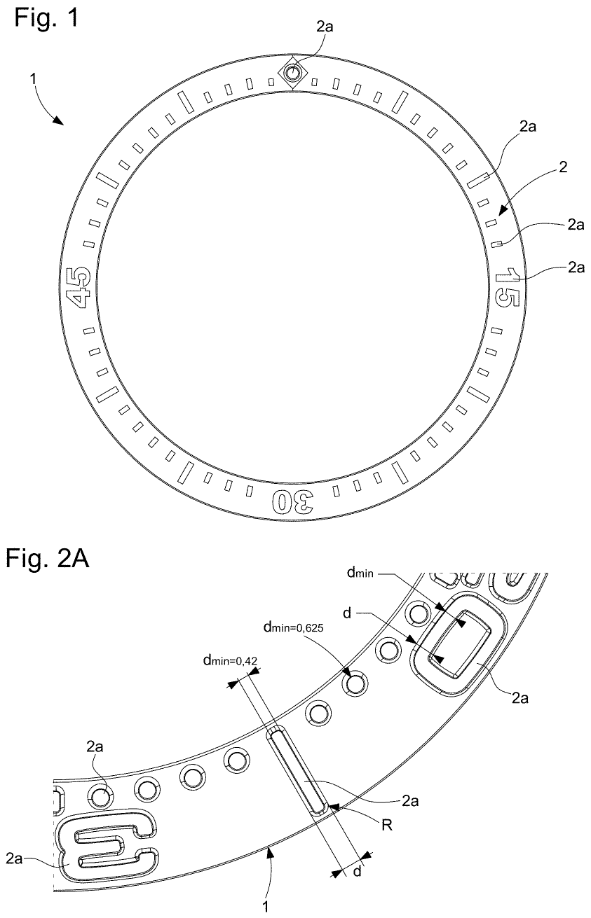

The item according to the invention can be a decorative item such as a constituent element of watches, jewellery, bracelets, etc. In the watchmaking field, this item can be an external component such as a middle part, a back, a bezel, a push-piece, a bracelet link, a dial, a hand, a dial index, etc. It can also be a component of the movement such as an oscillating mass, a plate, etc. By way of illustration, the item is a bezel 1 with a raised decoration 2 formed of distinct elements 2a which are indexes, numbers, rings, triangles, diamonds, etc. as shown in FIG. 1. In this example, all the elements are representative of a time scale which will also be called a minute-circle. Still by way of example, it could be a single element which is an acronym on a watch crown.

The item is made of a cermet or ceramic material. The material can thus be produced with one or more ceramics selected from nitrides, carbides and oxides such as zirconium oxide. Similarly, it can be produced with cermets including a ceramic phase with carbides, nitrides and/or oxides and a phase of a metallic binder selected, for example, from precious elements such as ruthenium, rhodium, palladium, osmium, iridium, platinum, gold and silver.

According to the invention, at least one of the elements 2a of the decoration 2 of the item is very thin with at least one dimension less than or equal to 1.5 mm, preferably 1 mm and more preferably 0.5 mm (FIG. 2A and FIG. 2B). The dimension is selected from a minimum height h and/or a minimum depth of the respectively raised and/or hollow element 2a and a minimum distance d separating two opposite faces of said element 2 in a plane transverse to said height/depth. For simple geometries of the circular type such as for the rings of the minute-circle or of the rectangular type for the indexes of the minute-circle, the minimum distance is thus related to the diameter and to the width respectively. For more complex geometries such as for a number or a recessed geometric shape (ring, triangle, etc.), it is the thickness of the number or the recessed geometric shape with the minimum thickness as the value taken within the number or the recessed shape.

The distance d or the height h/depth to be considered is the minimum. This means that if the height or the depth is variable within the element, it is the smallest height/depth which must be less than or equal to 1.5 mm, preferably less than or equal to 1 mm and more preferably less than or equal to equal to 0.5 mm. In the example shown, the height h is the same within the element and for all the elements and has a value of 0.3 mm. Likewise, the element may have dimensions in the transverse plane which are variable according to the height/depth. Thus, if the minimum distance d is variable between the different planes along the height/depth, it is the smallest value that must be considered. In the example shown, the base of the decorative elements is wider than the top with a minimum distance of 0.42 mm at the top of the index. The decoration is very thin with also small radii R of curvature at the junction between the contiguous faces of the element of the decoration. Typically, the radii of curvature are less than or equal to 0.1 mm and preferably less than or equal to 0.06 mm.

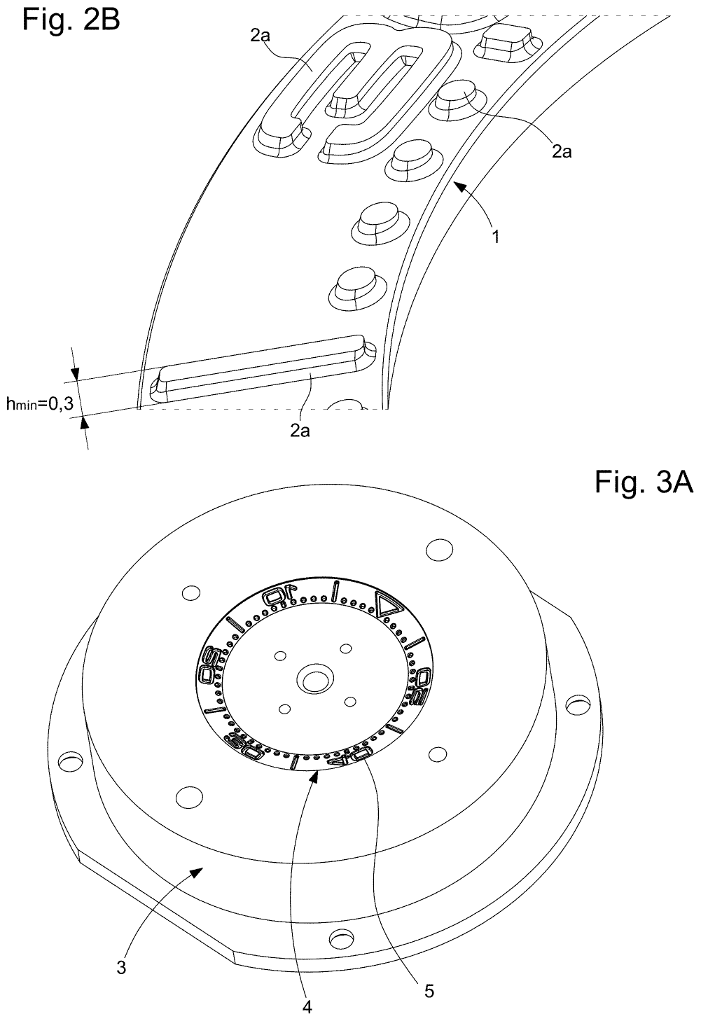

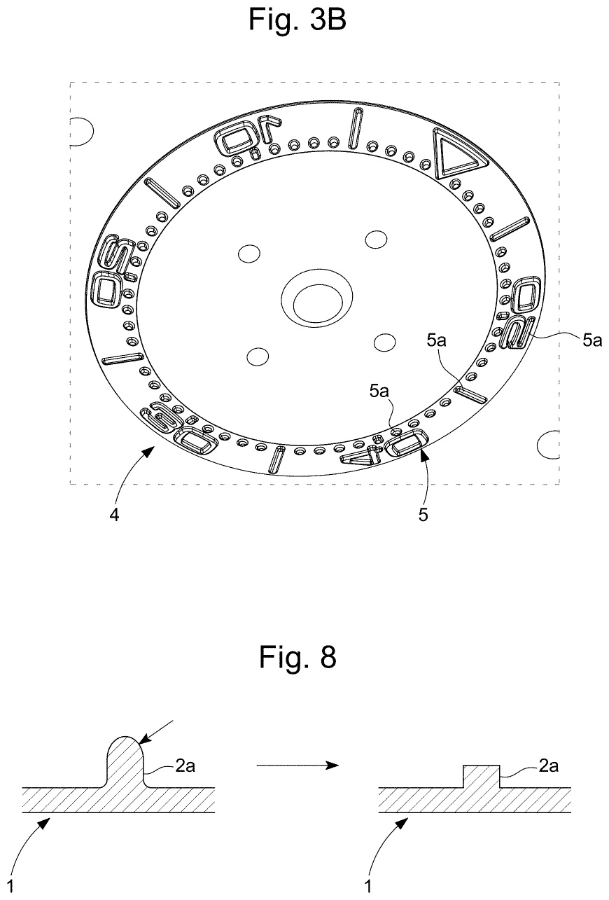

The impression 4 of the mould 3 visible in FIGS. 3A, 3B and 4 includes a raised and/or hollow structure 5 made of one element or several separate elements 5a which are negatives of the decoration to be produced. In the example of FIGS. 3A and 3B, the structure is hollow while in the example of FIG. 4, it is raised. In a manner similar to the decoration of the item, at least one element 5a of the structure 5 has at least one dimension less than or equal to 1.5 mm, said dimension being selected from a minimum height or depth of the respectively raised or hollow element 5a and a minimum distance d separating two opposite faces of said element 5 in a plane transverse to said height or depth. The minimum height/depth and minimum distance are to be measured as indicated for the decorative element(s) of the item.

The machining of the structure of the impression of the mould is carried out by micro-milling or laser ablation. Micro-milling is preferably carried out with a toroidal or hemispherical milling cutter having a diameter comprised between 0.1 and 3 mm and an angle radius at the end of the milling cutter comprised between 0.05 and 0.5 mm. Laser ablation is preferably performed with a pulsed laser such as a picosecond, nanosecond or femtosecond laser. Typically, the mould can be made of a metal alloy such as a hardened steel having a rockwell hardness HRC greater than 50. Conventionally, the impression of the mould before engraving can be obtained by milling, turning, etc.

The cermet or ceramic item is produced by injecting material into the mould provided with the impression with the raised and/or hollow structure. The method for manufacturing the item comprises the following steps:
Providing the injection mould as described above which includes at least one impression with the raised and/or hollow structure,
Providing at least one ceramic or cermet material,
Injecting said at least one material into the impression of the mould to form a green body provided with a decoration which is the negative of the structure of the impression,
Sintering the green body to form a blank,
Finishing the blank to obtain the item.

The method may optionally include a debinding step before the sintering step if the materials have been injected with a system of organic binders (paraffin, polyethylene, etc.).

During the injection step, the impression is heated to a temperature comprised between 50° C. and 170° C., preferably between 60° C. and 150° C., to allow good filling of the structure of the impression with the material.

The finishing step is a polishing and/or machining step. The machining at the decoration, which is optional, consists in removing the ridge of the element(s) 2a of the decoration when it is raised so as to produce marked edges at the junction between the upper face and the sides of the element of the decoration as schematically shown in FIG. 8.

The method for manufacturing the item according to the invention does not have an engraving step subsequent to the injection step or at least the majority of the decoration of the item is carried out during the injection.

Typically, a bezel 1 according to FIG. 1 is obtained by injection of zirconium oxide and by sintering at a temperature of 1500° C. for a time of 30 hours under an oxidising atmosphere.

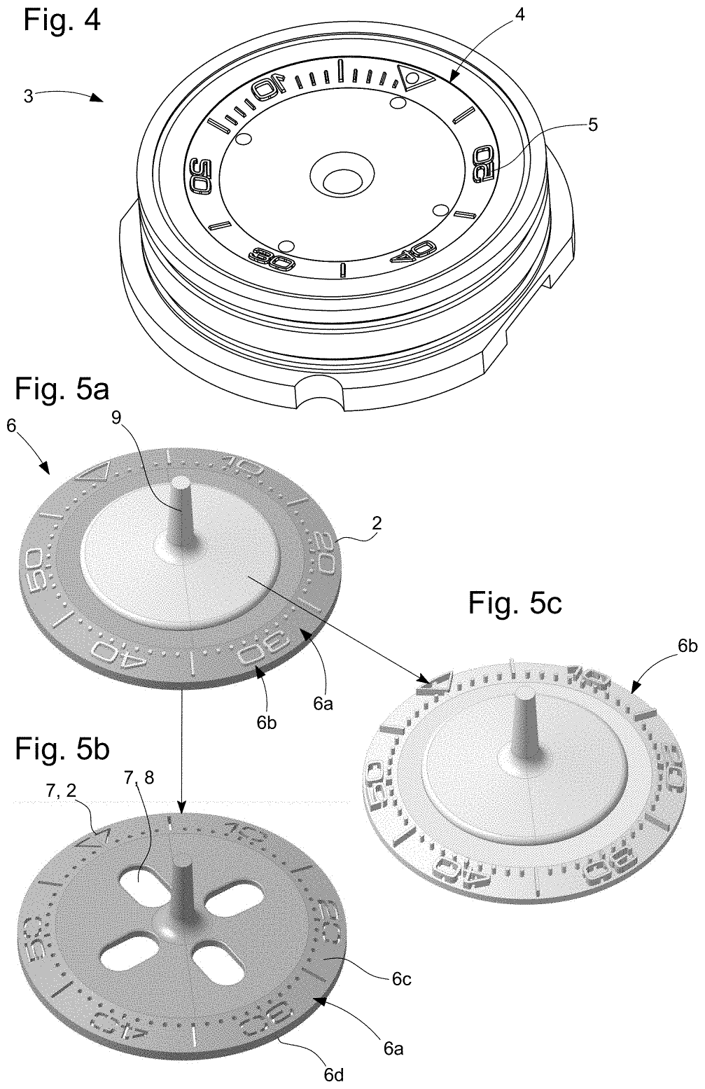

The manufacturing method according to the invention can also be implemented to produce items with several materials that differ, for example, by their colours. The objective is then to produce an item with a decoration of a given colour on a background of another colour. More specifically, the decoration is raised on the background. The injection step uses a first impression and a second impression respectively having a raised structure and a hollow structure machined according to the method of the invention. The first impression is used when injecting the first material and the second impression is used when injecting the second material. The green body 6 after the injection of the two materials is shown in FIG. 5a. The first part 6a of the green body resulting from the injection of the first material into the first impression is shown in FIG. 5b. The first part 6a includes recesses 7 passing through its thickness. These recesses 7 form, on the one hand, a decoration 2 and, on the other hand, one or more openings 8 for the injection of the second material. These openings 8 are preferably present on a portion of the green body intended to be removed during machining of the item. For a bezel, they are thus present in the central annular part of the bezel intended to be recessed.

This first part 6a of the green body is obtained after injection of the first material into a mould provided with the first impression with a raised structure forming the decoration and the opening(s). To make recesses passing through the thickness of the first part of the green body, said structure has a height greater than the filling height of the material in the first impression.

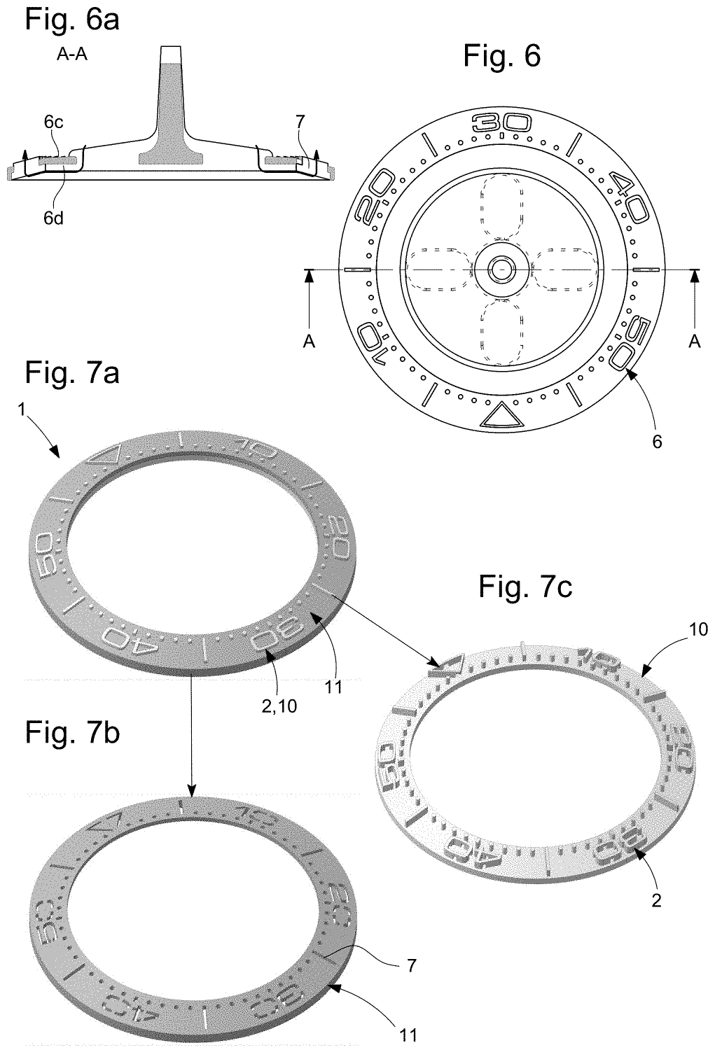

The second part 6b of the green body is obtained by injection of the second material via the openings 8 from the upper face 6c to the lower face 6d of the first part 6a. As schematically shown in FIG. 6a by the arrows, the second material then rises from the lower face 6d to the upper face 6c through the recesses 7 of the decoration 2 into the second impression (not shown). The latter has a hollow structure disposed facing the decoration of the first part of the green body, said structure having a shape similar to that of the decoration of the first part of the green body. The green body 6 formed of the first part 6a and of the second part 6b in FIG. 5a thus has a decoration 2 made with the second material raised on the first material. Then, to form a bezel, in a conventional manner, the sprue 9 is cut and the inner diameter of the bezel is hollowed to produce the item of FIG. 7a.

The manufacturing method has been illustrated for an item comprising two distinct materials, but it could be an item comprising 3, 4, etc. distinct materials with the production of several decorations of different colours.

The invention also relates to the item resulting from the manufacturing method.

For a multi-coloured item obtained according to the method described above (FIGS. 7a-7c), the item 1 has a base 10 of a colour provided with the raised decoration 2, surmounted by a part, called upper part 11, of another colour provided with recesses 7 of a shape complementary to the decoration 2 of the base 10, the upper part 11 being nested with the base 10 via the decoration 2 passing through the recesses 7 to stand raised on the upper part 11.

### LEGEND

1. Item or Bezel

2. Decoration
a. Element of the decoration

3. Injection mould

4. Impression

5. Raised and/or hollow structure of the impression
a. Element of the structure

6. Green body
a. First part with the first material
b. Second part with the second material
c. Upper face of the first part
d. Lower face of the second part

7. Recess

8. Opening

9. Sprue

10. Base of the item

11. Upper part of the item

1. A method for machining by laser ablation or by micro-milling a raised and/or hollow structure on an impression of an injection mould, said structure being made of one element or several separate elements with at least one element having at least one dimension less than or equal to 1.5 mm, said dimension being selected from a minimum height or depth of the respectively raised or hollow element and a minimum distance separating two opposite faces of said element in a plane transverse to said height or depth.

2. The machining method according to claim 1, wherein said at least dimension is less than or equal to 1 mm.

3. The machining method according to claim 1, wherein said at least dimension is less than or equal to 0.5 mm.

4. The machining method according to claim 1, wherein at least one element has a radius R of curvature less than or equal to 0.1 mm at the junction between two contiguous faces of the element in said transverse plane.

5. The machining method according to claim 1, wherein at least one element has a radius R of curvature less than or equal to 0.06 mm at the junction between two contiguous faces of the element in said transverse plane.

6. An injection mould, it wherein said injection mould is provided with at least one impression having a raised and/or hollow structure, said structure being made of one element or several separate elements with at least one element having at least one dimension less than or equal to 1.5 mm, said dimension being selected from a minimum height or depth of the respectively raised or hollow element and a minimum distance separating two opposite faces of said element in a plane transverse to said height or depth.

7. A method for manufacturing a ceramic or cermet item by injection comprising the following steps:
providing the injection mould provided with at least one impression having a raised and/or hollow structure, said structure being made of one element or several separate elements with at least one element having at least one dimension less than or equal to 1.5 mm, said dimension being selected from a minimum height or depth of the respectively raised or hollow element and a minimum distance separating two opposite faces of said element in a plane transverse to said height or depth,
providing providing at least one ceramic or cermet material,
injecting said at least one material into said at least one impression of the injection mould to form a green body provided with a decoration which is the negative of the structure of the impression,
sintering the green body to form a blank,
finishing the blank to obtain the item.

8. The manufacturing method according to claim 7, wherein the injection mould is provided with two impressions with a first impression having a raised structure and a second impression having a hollow structure, and wherein two distinct materials are provided with a first material injected into the first impression to form a first part of the green body and a second material injected through the first material into the second impression to form a second part of the green body.

9. The manufacturing method according to claim 8, wherein the first part of the green body comprises recesses passing through the thickness of said first part, said recesses forming the decoration and at least one opening, said second material being injected through the opening with a flow in a given direction before passing through the recesses of the decoration in a direction opposite to the given direction to end in the second impression provided with a structure of the same shape as the decoration of the first part of the green body, said structure being disposed facing the decoration of the first part during the injection.

10. The manufacturing method according to claim 9, wherein the opening is present on a portion of the first part of the green body intended to be removed during the step of finishing the blank.

11. The manufacturing method according to claim 7, wherein the first and the second material differ by their colour.

12. The manufacturing method according to claim 7, wherein, during the injection step, said at least one impression is heated to a temperature comprised between 50° C. and 170° C., to allow complete filling of the structure of the impression with the material.

13. The manufacturing method according to claim 7, wherein the finishing step is a polishing and/or machining step, the machining step consisting in removing the ridge of at least at one element of the raised decoration so as to produce edges at the junction between the upper face of said element and the sides of said element.

14. A cermet or ceramic item made by injection according to the manufacturing method of claim 7.

15. The item according to claim 14, wherein said item is formed of at least two distinct colours, with the decoration of a first colour which is raised on a background of a second colour.

16. The item according to claim 15, wherein said item has a base made of the first colour and provided with the raised decoration, said base being surmounted by a part, called upper part, made of the second colour, said upper part being provided with through recesses, of a shape complementary to the decoration of the base, the upper part being superimposed on the base with the decoration passing through the recesses to stand raised on the upper part.

17. The item according to claim 14, wherein the watch component of the external part or of the movement is selected from the list comprising a middle part, a back, a bezel, a push-piece, a bracelet link, a dial, a hand, a dial index, an oscillating mass and a plate.
